(19) United States
(12) Patent Application Publication
(10) Pub. No.: US 2004/0036867 A1
(43) Pub. Date: Feb. 26, 2004

(54) One-dimensional calibration standard

(76) Inventors: Ralf Jedamzik, Griesheim (DE); Armin Thomas, Engelestadt (DE); Thorsten Döhring, Mainz (DE)

Correspondence Address: Baker & Daniels, Suite 800, 111 East Wayne Street, Fort Wayne, IN, 46802, US

(21) Appl. No.: 10/276,562

(22) PCT Filed: Mar. 7, 2001
(86) PCT No.: PCT/EP01/02542

(30) Foreign Application Priority Data
May 15, 2000 (DE) 100 23 604.9

(51) Int. Cl. G01J 1/10

(52) U.S. Cl. 356/243.1

(57) ABSTRACT

The invention relates to a one-dimensional calibration standard for coordinate measuring devices, especially for optical coordinate measuring devices, so-called laser trackers that are provided with a rod-shaped calibration device. The inventive device is characterized in that the rod-shaped calibration device consists of a single material having a thermal expansion coefficient of <5×10⁻⁶K⁻¹ and that the rod-shaped calibration device is provided with at least two bores at predetermined calibrated intervals into which the reflective devices of the optical measuring device or the balls used for the calibration of scanning coordinate measuring systems can be exactly and reproducibly inserted and withdrawn in order to calibrate the coordinate measuring device.

The invention relates to a one-dimensional calibration standard for coordinate measuring instruments, especially optical coordinate measuring instruments with a rod-like calibration means.

In the case of optical or even mechanical coordinate measuring machines it is necessary to check the measurement precision of the coordinate measuring set-up from time to time.

For checking there are different kinds of calibration standards in coordinate metrology. The most commonly used one-dimensional calibration standards are for example step gauge blocks. Two-dimensional calibration standards are for example ball plates, three-dimensional calibration standards for optical coordinate measuring instruments, and laser trackers in particular, are triangular pyramids for example.

One-dimensional calibration standards are especially suitable for rapidly checking the measurement precision. The disadvantage of currently available one-dimensional calibration standards such as the step gauge blocks or a one-dimensional invar rod which is screwed together and comprises two receivers for the reflectors at its two ends is that these added structures are very sensitive to the ambient environment due to the material combination, so that especially measuring errors occur due to changes in position when the ambient temperature changes.

Optical coordinate measuring instruments, and laser trackers in particular, work according to the following principle:

The measuring station of the coordinate measuring instrument produces a laser beam which is guided towards a movable target. This target is a triple reflector which is built into a precisely manufactured steel housing such as a steel sphere. Such an arrangement is designed below in a general way as a reflection means or as a reflector. The diameter of the spherical reflector is 38.1 mm in a preferred embodiment.

The laser beam of the coordinate measuring instrument impinging upon the reflector is reflected by the reflector to the measuring station. The measuring station of the coordinate measuring instrument registers the exact position of the triple reflector which is situated precisely in the middle of the steel sphere. The optical coordinate measuring instrument or the laser tracker can precisely determine the position of the reflector with a precision of 10 μm from the distance and the two angular values.

It is the object of the present invention to provide a one-dimensional calibration standard which shows little sensitivity to the ambient environment and is especially suitable for laser trackers.

The object to provide a one-dimensional calibration module for optical coordinate measuring instruments in particular is achieved in such a way that the one-dimensional calibration standard with rod-like calibration means is arranged in such a way that the rod-like calibration means consists of a single material which shows a thermal expansion <5×10⁻⁶K⁻¹ and the rod-like calibration means comprises at least two bores at a predetermined calibrated distance into which the reflection means of the optical coordinate measuring instrument and/or balls can be introduced or removed in a precise and reproducible manner for the calibration of scanning coordinate measuring instruments in order to calibrate the measuring instrument.

The thermal expansion of the material for the rod-like calibration means can show a thermal expansion <5×10⁻⁶K⁻¹ and especially preferably one of <0.1×10⁻⁶K⁻¹.

Especially preferably the material is a glass ceramics, especially Zerodur (brand name of Schott Glas, Mainz).

The rod-like calibration means shows bores preferably in form of conical bores. In order to hold the balls or the spherical reflectors in the conical bores even in the case of strongly inclined positions, it is provided for in a special embodiment of the invention to provide a magnet under each conical bore. Said magnets can be fastened with a special clamping technique and can also be dismounted again when required.

Preferably, spherical reflectors are used as reflection means which comprise a triple reflector in a precisely manufactured steel housing.

In order to increase the measurement precision, the balls for calibrating scanning systems can be made of a material with low thermal expansion, e.g. of invar.

In addition to the one-dimensional calibration standard, the invention also provides a method for calibrating an optical coordinate measuring instrument, especially a laser tracker with a one-dimensional calibration module in accordance with the invention. The method in accordance with the invention is characterized in that the spherical reflector is placed into a first bore of the calibration standard, a first position is determined and thereafter the reflector is removed from the first bore. Then the reflector is introduced into a second bore, the position is determined again and it is removed from the second bore.

The measured distance of the bores is determined from the first and second position and compared with the certified distance. On the basis of this comparison, the optical coordinate measuring instrument, and the laser tracker in particular, is then calibrated accordingly.

The invention also provides a method for calibrating a scanning coordinate measuring instrument.

In such a method, the balls for calibrating the scanning coordinate measuring instruments are placed in the bores, the coordinate measuring instrument scans a first ball, its position is then determined, and in a second step the coordinate measuring instrument scans a second ball. A second position is determined. The measured distance of the bores is determined from the first and second position and compared with the certified distance. On the basis of this comparison the scanning coordinate measuring instrument is then calibrated accordingly.

The invention is now described in closer detail by way of an example on the basis of the drawings, wherein:

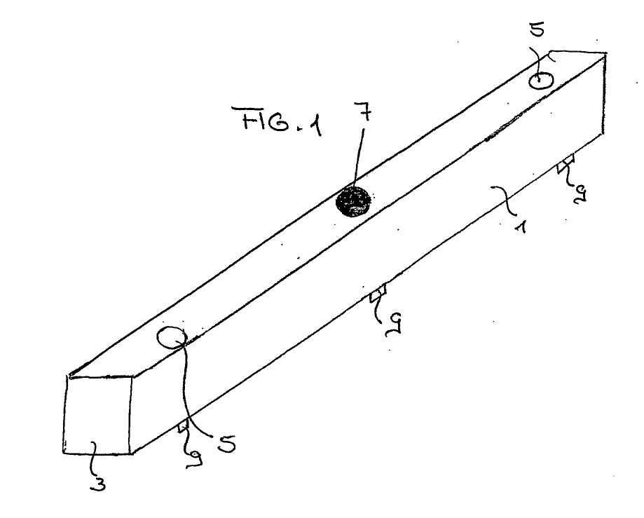

FIG. 1 shows a one-dimensional calibration standard in accordance with the invention in a three-dimensional view.

FIG. 1 schematically shows a calibration standard in accordance with the invention. The calibration standard consists of a Zerodur rod 1 with a square profile 3. A total of three conical bores 5 are incorporated in the Zerodur rod 1 in the embodiment as shown in FIG. 1. The bores are arranged in such a way that a ball or a spherical reflector with a diameter of 38.1 mm can be placed in a precise a reproducible manner.

The sphere or the spherical reflector 7 for the optical coordinate measuring instruments, and the laser tracker in particular, consists advantageously of stainless special steel and has a diametrical and roundness precision of better than 0.001 mm. In order to increase the measurement precision it is especially advantageous when the balls 7 for calibrating scanning coordinate measurement instruments are made of invar, because this material is characterized by a very low coefficient of thermal expansion. In order to hold the balls or the spherical reflectors 7 in the conical bores 5 even in the case of a strongly inclined position of the calibration standard, magnets 9 are provided under each conical bore 5. Said magnets are fastened with a special clamping technique and can also be dismounted again when required.

In an especially preferable embodiment of the invention which is not shown herein, the calibration standard 1 has a length of 110 mm and a width of 60 mm. A total of six conical bores are incorporated in such a calibration standard instead of the three bores as shown in FIG. 1. These bores are also designed in such a way that a ball or spherical reflector can be placed in the bores in a precise and reproducible manner.

For the purpose of enabling the calibration standard to be used for calibration or gauging of coordinate measuring instruments, it is necessary at first to precisely determine and certify the distances between the bores. This occurs for example by using balls 7 for scanning coordinate measuring instruments in the individual bores and their scanning. Due to these measurements, the calibration standard is certified by PTB, Braunschweig, for example. For the purpose of enabling the performance of a precision check of an optical coordinate measuring system such as a laser tracker for example, the calibration module is set up at a defined distance and position to the optical coordinate measuring instrument such as the laser tracker. The spherical reflector is placed at first in the first of six measuring positions for example which are represented by the conical bores. The position is now measured with the help of the coordinate measuring system. It is proceeded similarly with the further measuring positions and bores. At the end of this measuring cycle the distances of the measuring positions are determined and compared with the certified values. In this way it is possible to check the precision of the respective coordinate measuring instrument, and the laser tracker in particular.

By using Zerodur as the material for the rod-like element 1 and by determining the measuring positions for the reflectors by introducing bores into the solid material Zerodur, a high temperature stability is achieved. In particular, measuring errors by positional changes due to the very low coefficient of expansion of Zerodur (brand name of Schott Glas) are avoided. As a result of the fact that the spherical reflector or the ball 7 is directly in contact with Zerodur, the influence of other materials is avoided. The calibration standard in accordance with the invention is further characterized by very simple handling, such that in the present calibration standard the reflector is inserted in the respective conical bores and thereafter the position of the reflector is determined with a high amount of reproducibility and thereafter the spherical reflector is taken from the conical bore.

It is understood that it would be possible, without departing from the invention, to provide the calibration standard with other geometrical dimensions or another number of conical bores.

Moreover, the conical bores are naturally always adjusted to the respective types of reflectors, e.g. when they are not provided with a round shape.

1. A one-dimensional calibration standard for coordinate measuring instruments, especially optical coordinate measuring instruments, so-called laser trackers, having
a rod-like calibration means (1), characterized in that
the rod-like calibration means (1) consists of a single material comprising a thermal expansion of <5×10⁻⁶K⁻¹ and
that the rod-like calibration means (1) comprises at least two bores (5) at a predetermined calibrated distance into which the reflection means of the optical measuring instrument or the balls can be introduced in a precise and reproducible manner for the calibration of scanning coordinate measuring systems and can be removed therefrom in order to calibrate the coordinate measuring instrument.

2. A one-dimensional calibration standard as claimed in claim 1, characterized in that the material comprises a thermal expansion of <2×10⁻⁶K⁻¹.

3. A one-dimensional calibration standard as claimed in claim 1 or 2, characterized in that the material comprises a thermal expansion of <0.1×10⁻⁶K⁻¹.

4. A one-dimensional calibration module as claimed in one of the claims 1 to 3, characterized in that the material is a glass ceramic material, especially Zerodur.

5. A one-dimensional calibration standard as claimed in one of the claims 1 to 4, characterized in that the bores are conical bores (5).

6. A one-dimensional calibration standard as claimed in one of the claims 1 to 5, characterized in that magnetic devices (9) are arranged below the individual bores.

7. A one-dimensional calibration standard as claimed in one of the claims 1 to 6, characterized in that the reflection means for the optical coordinate measuring instruments have a spherical shape.

8. A method for calibrating an optical coordinate measuring instrument, and a laser tracker in particular, with a one-dimensional calibration module as claimed in one of the claims 1 to 7, comprising the following steps:
the reflection means are placed into a first bore of the calibration standard, a first position is determined with the help of the optical coordinate measuring instrument and thereafter removed from the first bore;
the reflection means are placed into a second bore of the calibration standard, a second position is determined with the help of the optical coordinate measuring instrument and thereafter removed from the bore;
the distance of the bores is determined from the first determined position and the second determined position, compared with the certified distance and the optical coordinate measuring instrument is calibrated on the basis of said comparison.

9. A method for calibrating a scanning coordinate measuring instrument with a one-dimensional calibration module as claimed in one of the claims 1 to 7, comprising the following steps:
the balls (7) are placed into the bores (5);
the coordinate measuring instrument scans a first ball, then a first position is determined;
the coordinate measuring instrument scans a second ball, then a second position is determined;
the distance of the bores is determined from the first and second position, compared with the certified distance and the scanning coordinate measuring instrument is calibrated on the basis of said comparison.

10. The use of a one-dimensional calibration standard as claimed in one of the claims 1 to 7 as a calibration standard for optical coordinate measuring instruments, and laser trackers in particular.
